(19) United States
(12) Patent Application Publication
(10) Pub. No.: US 2008/0284780 A1
(43) Pub. Date: Nov. 20, 2008

(54) METHOD FOR ENABLING ALPHA-TO-COVERAGE TRANSFORMATION

(76) Inventor: R-Ming Hsu, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/749,153

(22) Filed: May 15, 2007

(51) Int. Cl. G06T 15/40

(52) U.S. Cl. 345/422

(57) ABSTRACT

An alpha-to-coverage transformation is performed by a pixel shader. The pixel shader compares data of a transparency column of a pixel and thresholds of sub-pixels of the pixel to generate a plurality of coverage masks, and stores the plurality of coverage masks in the LSBs of the transparency column of the pixel, and finally update the data of the sub-pixels according to the coverage masks stored in the transparency column of the pixel. A new instruction “a2c” is invented to speed up such thresholds comparison and coverage mask generation.

### BACKGROUND OF THE INVENTION

1. Field of the Invention

The invention relates to a method for enabling alpha-to-coverage transformation, and more particularly, to a method for enabling alpha-to-coverage transformation by a specific instruction of a pixel shader.

2. Description of the Prior Art

The technology of three-dimensional (3-D) computer graphics concerns the generation, or rendering of two-dimensional (2-D) images of 3-D objects for showing onto a display device. The object may be a simple geometry primitive such as a point, a line segment, a triangle, or a polygon. More complex objects can be rendered onto a display device by representing the objects with a series of connected planar polygons, such as, for example, by representing the objects as a series of connected planar triangles. All geometry primitives may eventually be described in terms of one vertex or a set of vertices, for example, coordinate (x, y, z) that defines a point, for example, the endpoint of a line segment, or a corner of a polygon.

To generate a data set for display as a 2-D projection representative of a 3-D primitive onto a computer monitor or other display device, the vertices of the primitive are processed through a series of operations, or processing stages in a graphics-rendering pipeline. A generic pipeline is merely a series of cascading processing units, or stages, wherein the output from a prior stage serves as the input for a subsequent stage. In the context of a graphics processor, these stages include, for example, per-vertex operations, primitive assembly operations, pixel operations, texture assembly operations, rasterization operations, and fragment operations.

In a typical graphics display system, an image database (e.g., a command list) may store a description of the objects in the scene. The objects are described with a number of small polygons, which cover the surface of the object in the same manner that a number of small tiles can cover a wall or other surface. Each polygon is described as a list of vertex coordinates (X, Y, Z in “Model” coordinates) and some specification of material surface properties (i.e., color, texture, shininess, etc.), as well as possibly the normal vectors to the surface at each vertex. For three-dimensional objects with complex curved surfaces, the polygons in general must be triangles or quadrilaterals, and the latter can always be decomposed into pairs of triangles.

A transformation engine transforms the object coordinates in response to the angle of viewing selected by a user from user input. In addition, the user may specify the field of view, the size of the image to be produced, and the back end of the viewing volume so as to include or eliminate background as desired.

Once this viewing area has been selected, clipping logic eliminates the polygons (i.e., triangles) which are outside the viewing area and “clips” the polygons, which are partly inside and partly outside the viewing area. These clipped polygons will correspond to the portion of the polygon inside the viewing area with new edge(s) corresponding to the edge(s) of the viewing area. The polygon vertices are then transmitted to the next stage in coordinates corresponding to the viewing screen (in X, Y coordinates) with an associated depth for each vertex (the Z coordinate). In a typical system, the lighting model is next applied taking into account the light sources. The polygons with their color values are then transmitted to a rasterizer.

For each polygon, the rasterizer determines which pixel positions are covered by the polygon and attempts to write the associated color values and depth into a frame buffer. The rasterizer compares the depth values for the polygon being processed with the depth value of a pixel, which may already be written into the frame buffer. If the depth value of the new polygon pixel is smaller, indicating that it is in front of the polygon already written into the frame buffer, then its value will replace the value in the frame buffer because the new polygon will obscure the polygon previously processed and written into the frame buffer. This process is repeated until all of the polygons have been rasterized. At that point, a video controller displays the contents of a frame buffer on a display one scan line at a time in raster order.

The default methods of performing real-time rendering typically display polygons as pixels located either inside or outside the polygon. The resulting edges which, define the polygon, can appear with a jagged look in a static display and a crawling look in an animated display. The underlying problem producing this effect is called aliasing and the methods applied to reduce or eliminate the problem are called anti-aliasing techniques.

Screen-based anti-aliasing methods do not require knowledge of the objects being rendered because they use only the pipeline output samples. One typical anti-aliasing method utilizes a line anti-aliasing technique called Multi-Sample Anti-Aliasing (MSAA), which takes more than one sample per pixel in a single pass. The number of samples or sub-pixels taken for each pixel is called the sampling rate and, axiomatically, as the sampling rate increases, the associated memory traffic also increases.

Please refer to FIG. 1. FIG. 1 is a functional flow diagram of certain components within a graphics pipeline in a computer graphics system. It will be appreciated that components within graphics pipelines may vary from system to system, and may also be illustrated in a variety of ways. Vertex data of graphics are transmitted to a vertex shader 12. The vertex shader 12 may perform various transformations on the graphics data received from the command list. The data may be transformed from World coordinates into Model View coordinates, then into Projection coordinates, and ultimately into Screen coordinates. The functional processing performed by the vertex shader 12 is known and need not be described further herein. Thereafter, the graphics data may be passed onto rasterizer 14 for geometric processing. Then, the information of the pixels relating to the primitive is passed on to the pixel shader 16 which determines color information for each of the pixels within the primitive that are determined to be closer to the current viewpoint.

For pixel rendering 18, a depth test is performed on each pixel within the primitive. The stored depth value is provided for a previously rendered primitive for a given pixel location. If the current depth value indicates a depth that is closer to the viewer's eye than the stored depth value, then the current depth value will replace the stored depth value and the current graphic information (i.e., color) will replace the color information in the corresponding frame buffer pixel location (as determined by the pixel shader 16). If the current depth value is not closer to the current viewpoint than the stored depth value, then neither the frame buffer nor depth buffer contents need to be replaced, as a previously rendered pixel will be deemed to be in front of the current pixel.

### SUMMARY OF THE INVENTION

The present invention provides a method for enabling alpha-to-coverage transformation comprising a pixel shader comparing a datum in a transparency column of a pixel to a plurality of thresholds of a plurality of sub-samples of the pixel for generating a plurality of coverage masks; storing the plurality of coverage masks in least significant bits of the transparency column of the pixel; and updating data of the sub-samples according to the plurality of coverage masks stored in the transparency column of the pixel.

The present invention further provides a method for enabling alpha-to-coverage transformation comprising inputting an instruction for triggering a pixel shader comparing a datum in a transparency column of a pixel to a plurality of thresholds of a plurality of sub-samples of the pixel for generating a plurality of coverage masks; and updating data of the sub-samples according to the plurality of coverage masks stored in the transparency column of the pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional flow diagram of certain components within a graphics pipeline in a computer graphics system.

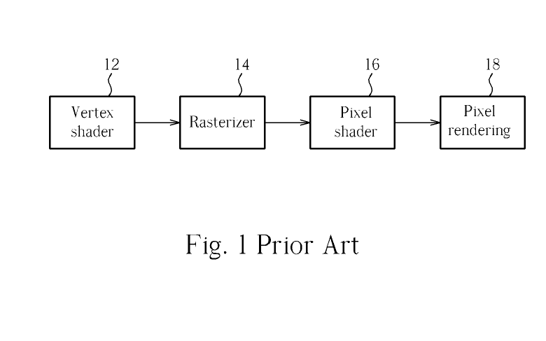

FIG. 2 is a perspective view of performing an alpha-to-coverage transformation.

FIG. 3 is a perspective view of a transparency column.

FIG. 4 is a flowchart for performing the alpha-to-coverage transformation.

FIG. 5 is a perspective view of a first embodiment of performing the alpha-to-coverage transformation.

FIG. 6 is a perspective view of utilizing a dither table to perform the alpha-to-coverage transformation.

FIG. 7 is a perspective view of performing an alpha-to-coverage transformation according to the second embodiment of the present invention.

### DETAILED DESCRIPTION

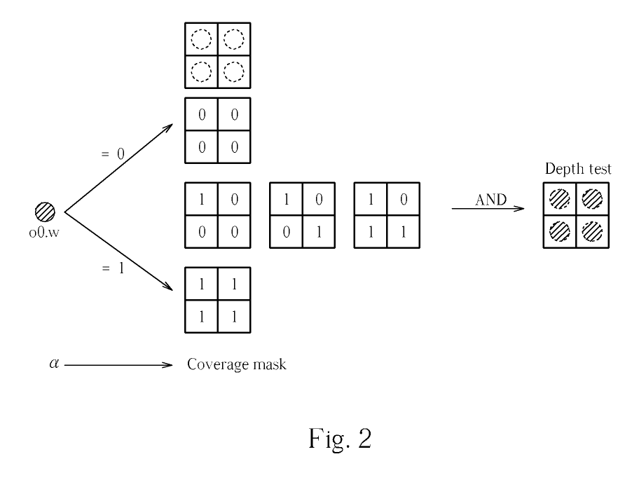

Please refer to FIG. 2. FIG. 2 is a perspective view of performing an alpha-to-coverage transformation. The alpha-to-coverage transformation is a method which is capable of drawing boundary transparency and masks of objects without queuing the objects. When performing the alpha-to-coverage transformation, a value in a transparency column of a pixel is converted to corresponding coverage masks which corresponds to n bits of n sub-samples of nX MSAA, and the corresponding coverage ratio is 1. Take 4X MSAA as an example, when the value in a transparency column of a pixel is 0, the coverage mask is 0000b. When the value in a transparency column of a pixel is 1, the coverage mask is 1111b. The value between 0 and 1 is converted to corresponding coverage masks. The coverage masks and the result of the depth test of each sub-sample corresponding to the pixel will result in valid bits. Then by performing an AND gate operation of the valid bits and corresponding coverage masks, valid sub-samples will remain. Thus a dithering effect corresponding to coverage can be generated. And a drawing can be well blended with its background after utilizing the MSAA.

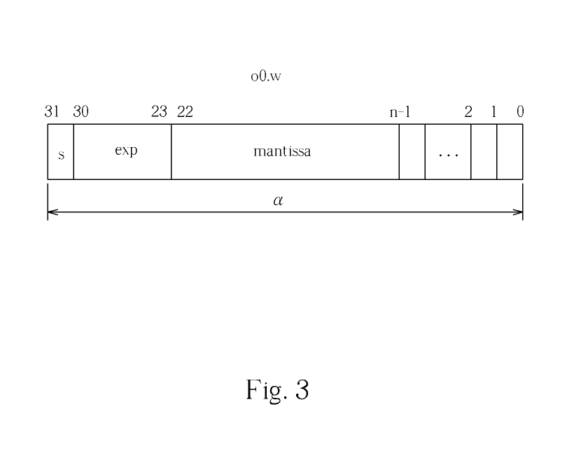

Please refer to FIG. 3. FIG. 3 is a perspective view of a transparency column. The transparency column in an application program is o0.w, and the application program can turn on its alpha-to-coverage transformation function by setting a flag enA2C. The transparency column is a 32-bit floating value. After turning on the alpha-to-coverage transformation function, the transparency value α in the transparency column will be read because precision is not required for the transparency value yet. In this embodiment, the n LSBs (least significant bits) in the transparency column will be used to store the coverage masks. Moreover, the graphic processing procedure which utilizes the transparency column also includes the alpha-test and alpha blending. When the flag enA2C is set as 0, the transparency value α is the 32-bit floating value in the transparency column. When the flag enA2C is set as 1, the n LSBs in the transparency column are set as 0, and the transparency value α is still obtained from the transparency column. Therefore, the coverage mask can be encoded on the n LSBs of the transparency column, and the output buffer becomes optional.

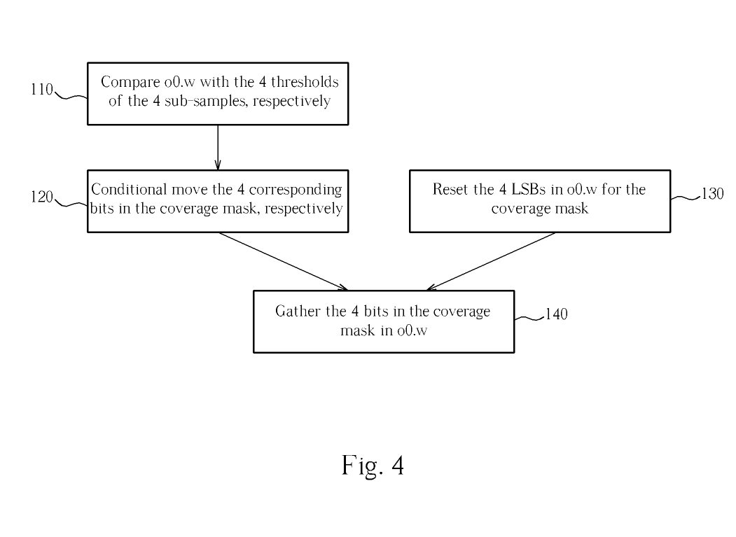

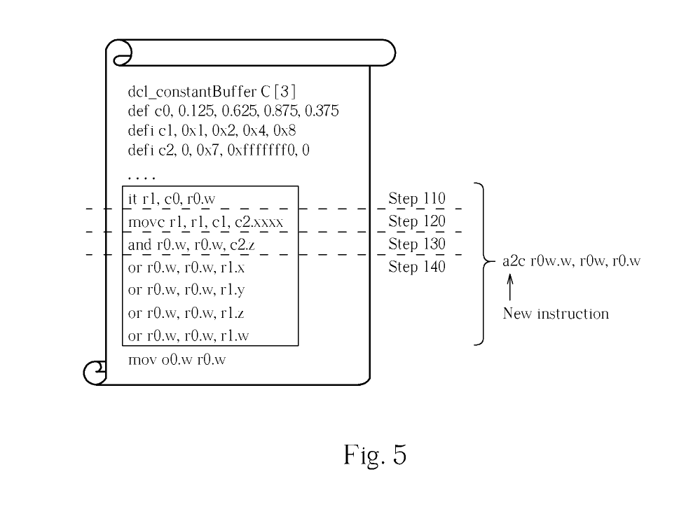

Please refer to FIGS. 4 and 5. FIG. 4 is a flowchart for performing the alpha-to-coverage transformation. FIG. 5 is a perspective view of a first embodiment of performing the alpha-to-coverage transformation. The alpha-to-coverage transformation is performed by comparing the transparency value in the transparency column and thresholds of n sub-samples of a corresponding MSAA so as to obtain the n-bit coverage masks. The alpha-to-coverage transformation comprises the following four steps:

Step 110: use comparison instructions such as “lt” (less than), “le” (less than or equal to), “ge” (greater than) or “ge” (greater than or equal to) of a pixel shader to compare the transparency column (o0.w) of the last color output by a pixel with four sub-pixel thresholds, and put the results in the four columns;

Step 120: use “movc” (conditional move) instruction to determine the four bits in the coverage masks according to the results in the four columns respectively, and store the four bits back to the four columns;

Step 130: update the four LSBs in the o0.w as 0, and use “and” instruction to cover the LSBs;

Step 140: gather the four bits in the coverage masks in o0.w.

Steps 110 to 140 are not limited to the above sequence. They can be of other sequences. As shown in FIG. 4, the comparison results of steps 110, 120 can only be true or false. If true, then all four columns are updated as 1. If false, then all four columns are updated as 0. Therefore one more instruction is required to convert the comparison result into a corresponding bit of the coverage masks. Steps 130, 140 are for encoding the coverage masks into the o0.w. Take the 4X MSAA as an example, if an original instruction set of a pixel shader is used to process steps 110 to 140, then at least seven instructions are needed. Thus in the present embodiment, if one new instruction “a2c” is used to process steps 110 to 140, then the new instruction can be used to replace the four instructions for o0.w, and no source/destination buffer needs to be designated. But if an adequate source/destination buffer is added, then the use of the instructions of the pixel shader can be made more flexible. For example, when o0.w is output by a single “mov” (move) instruction, then steps 110 to 114 can be replaced by the “a2c” instruction.

According to the embodiment of the present invention, steps 110 to 140 can be performed by issuing the “a2c” instruction. The format of the “a2c” instruction is a2c dest[.mask], src0[.swizzle], src1[.swizzle] which is performed in the pixel shader. The “a2c” instruction is used to compare the source buffer and the four thresholds corresponding to the sub-pixels of the MSAA respectively, and to store the generated coverage masks in the four LSBs (bit 3 to bit 0) of the destination buffer. For instance, when the four columns of scrl and four thresholds (0.125, 0.625, 0.875, 0.375) of the corresponding sub-pixels of the MSAA are compared by the “lt” instruction, if a column is smaller than its respective threshold, then the corresponding LSB of the output buffer is 1; otherwise is 0. All other bits are transferred directly from the corresponding bits in src0. The “a2c” instruction can share hardware with original comparison instructions. The only additional hardware is for instruction output. All columns of the source/destination buffer can share the existing hardware. And the processing efficiency is greatly enhanced.

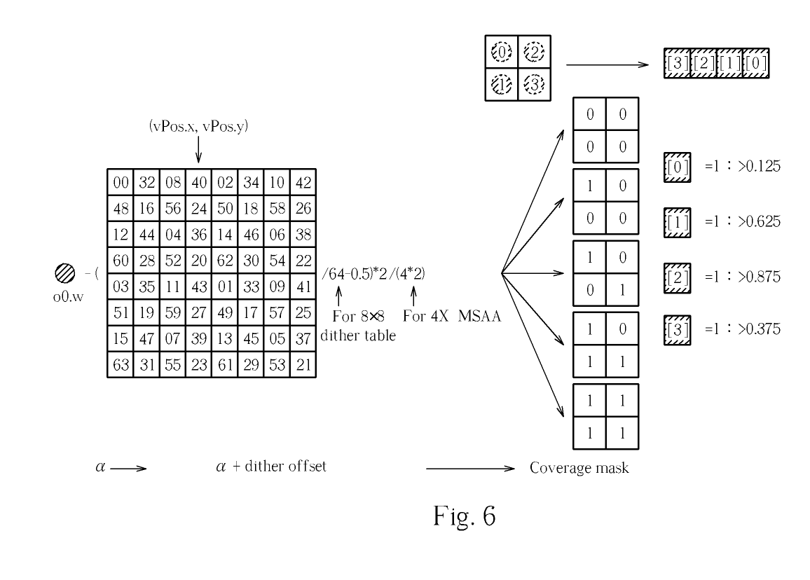

Please refer to FIG. 6. FIG. 6 is a perspective view of utilizing a dither table to perform the alpha-to-coverage transformation. To achieve a better result, the dithering of the alpha-to-coverage transformation can be disturbed to avoid generating a uniform pattern. The disturbance can be performed by using random numbers or by using random positions. Using random positions can better control the effect of the pattern. Take the 4X MSAA as an example. According to the position of a pixel on the screen, check an 8×8 dither table to find a random number between −0.5 and 0.5. Add the random number to the transparency column, then compare the added number with the threshold of each bit in the coverage masks. Then four bit coverage masks can be obtained. Afterwards, an AND gate operation can be performed on the coverage masks and the depth test result of each sub-sample corresponding to the pixel to obtain a high quality alpha-to-coverage transformation.

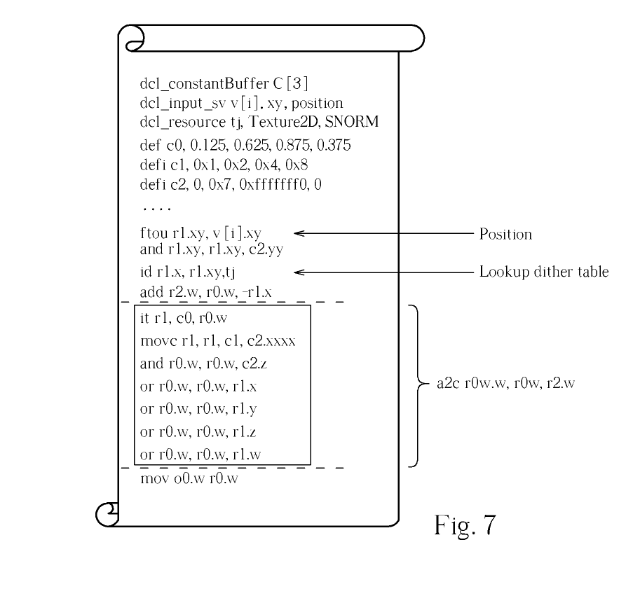

Please refer to FIG. 7. FIG. 7 is a perspective view of performing an alpha-to-coverage transformation according to the second embodiment of the present invention. The dither table generated in FIG. 6 can be stored in a texture or constant format. Use the Id instruction to access the dither table in the texture in the format, or use an index to access dither table in the constant format so as to obtain the random number. Then the transparency column is disturbed by adding the random number, and the coverage masks are obtain by the “a2c” instruction. Increasing the disturbance comprises four steps. It can be accomplished by using the four instructions of the pixel shader. The steps of storing the dither table in the texture format is as follows:

Step 210: change the 2-D position of a pixel on the screen from a floating number to an integer, which is performed by a conversion instruction “ftou”;

Step 220: use the 2-D integer obtained in Step 210 and an AND instruction to generate an index required for checking dither table such as the 8×8 dither table so as to generate the three LSBs. This step is also achievable by using the remainder function of the “udiv” instruction;

Step 230: access the dither table with the coordinate generated in Step 220, which is performed by an “ld” instruction;

Step 240: add the result of Step 230 to the transparency column to cause disturbance, which is performed by an “add” instruction.

When the dither table is stored in the constant format, Step 230 and Step 240 are respectively replaced with Step 330 and Step 340 because the constant can only be accessed by a 1-D index.

Step 330: generating the constant index by a “mad” instruction”;

Step 340: use the index generated in Step 330 to generate the constant, then add the constant into the transparency column to cause the disturbance, which is performed by the “add” instruction.

Both of the aforementioned methods can be accomplished by the four instructions of the pixel shader. Use the “a2c” instruction to obtain the coverage mask. Then a high quality alpha-to-coverage transformation can be obtained.

The embodiment of the present invention uses a 4X MSAA to process the alpha-to-coverage transformation as an example. However, this should not be used to construe the scope of the present invention. For example, 2X MSAA and 1X MSAA are also feasible. Further when using an nX MSAA where n>4, because the “a2c” instruction can only compare the four thresholds of sub-samples corresponding the nX MSAA, the “a2c” instruction can be converted to a group of “a2c_m” instruction. For example, the “a2c” instruction of the 4X MSAA is “a2c_{—}1”. The 8X MSAA requires “a2c_{—}1” and “a2c_{—}2”. The 16X MSAA requires “a2c_{—}1”, “a2c_{—}2”, “a2c_{—}3” and “a2c_{—}4”. Each “a2c_m” instruction is responsible for comparing the four thresholds of sub-samples corresponding the nX MSAA. And the generated coverage masks are stored in bit(4m-1)˜bit(4m-4) of the destination buffer.

In conclusion, the alpha-to-coverage transformation utilizing the pixel shader can enhance efficiency. Further storing the coverage masks of the pixel in the LSBs of the transparency column can reduce cost. The pixel shader compares the data of the transparency column of the pixel and the thresholds of the sub-pixels of the pixel to generate the plurality of coverage masks, then stores the plurality of coverage masks in the LSBs of the transparency column of the pixel, and finally update the data of the sub-pixels according to the coverage masks stored in the transparency column of the pixel. The alpha-to-coverage transformation can be implemented by software or hardware. Using software can be implemented by a single tool, a portion of a program loader, a portion of a device driver, or a compiler. When implemented by hardware, it can be integrated into the graphic processing unit or the pixel shader before the fetch instruction or decoding instruction.

Those skilled in the art will readily observe that numerous modifications and alterations of the device and method may be made while retaining the teachings of the invention.

What is claimed is:

1. A method for enabling alpha-to-coverage transformation comprising:
a pixel shader comparing a datum in a transparency column of a pixel to a plurality of thresholds of a plurality of sub-samples of the pixel for generating a plurality of coverage masks;
storing the plurality of coverage masks in least significant bits of the transparency column of the pixel; and
updating data of the sub-samples according to the plurality of coverage masks stored in the transparency column of the pixel.

2. The method of claim 1 wherein the pixel shader comparing the datum in the transparency column of the pixel to the plurality of thresholds of the plurality of sub-samples of the pixel for generating the plurality of coverage masks comprises:
comparing the datum in the transparency column of the pixel to the plurality of thresholds of the plurality of sub-samples of the pixel, and storing a comparison result in a buffer; and
generating the plurality of coverage masks according to the comparison result, and storing the plurality of coverage masks in the buffer.

3. The method of claim 1 further comprising accessing the plurality of coverage masks from the buffer.

4. The method of claim 1 wherein the pixel shader comparing the datum in the transparency column of the pixel to the plurality of thresholds of the plurality of sub-samples of the pixel for generating the plurality of coverage masks is the pixel shader comparing the datum in the transparency column of the pixel to four thresholds of four sub-samples of the pixel for generating four coverage masks.

5. The method of claim 1 further comprising enabling a flag of alpha-to-coverage transformation.

6. The method of claim 1 further comprising:
generating a dither table corresponding to positions on a display panel;
generating a plurality of indices of the dither table;
accessing the dither table according to the plurality of indices; and
storing a value accessed from the dither table in the transparency column of the pixel.

7. The method of claim 1 further comprising:
generating a depth test datum for each sub-sample of the pixel; and
performing an AND gate operation of the coverage mask and the depth test datum of the sub-sample.

8. The method of claim 1 further comprising performing an instruction for the threshold comparison and the coverage mask generation.

9. A method for enabling alpha-to-coverage transformation comprising:
inputting an instruction for triggering:
a pixel shader comparing a datum in a transparency column of a pixel to a plurality of thresholds of a plurality of sub-samples of the pixel for generating a plurality of coverage masks; and
updating data of the sub-samples according to the plurality of coverage masks stored in the transparency column of the pixel.

10. The method of claim 9 wherein the pixel shader comparing the datum in the transparency column of the pixel to the plurality of thresholds of the plurality of sub-samples of the pixel for generating the plurality of coverage masks comprises:
comparing the datum in the transparency column of the pixel to the plurality of thresholds of the plurality of sub-samples of the pixel, and storing a comparison result in a buffer; and
generating the plurality of coverage masks according to the comparison result, and storing the plurality of coverage masks in the buffer.

11. The method of claim 9 wherein inputting the instruction further triggering accessing the plurality of coverage masks from the buffer.

12. The method of claim 9 wherein the pixel shader comparing the datum in the transparency column of the pixel to the plurality of thresholds of the plurality of sub-samples of the pixel for generating the plurality of coverage masks is the pixel shader comparing the datum in the transparency column of the pixel to four thresholds of four sub-samples of the pixel for generating four coverage masks.

13. The method of claim 9 wherein inputting the instruction further triggering enabling a flag of alpha-to-coverage transformation.

14. The method of claim 9 further comprising:
generating a dither table corresponding to positions on a display panel;
generating a plurality of indices of the dither table;
accessing the dither table according to the plurality of indices; and
storing a value accessed from the dither table in the transparency column of the pixel.

15. The method of claim 9 further comprising:
generating a depth test datum for each sub-sample of the pixel; and
performing an AND gate operation of the coverage mask and the depth test datum of the sub-sample.

16. The method of claim 9 wherein inputting the instruction further triggering storing the plurality of coverage masks in the least significant bits of the transparency column of the pixel.
